(19) United States
(12) Patent Application Publication
(10) Pub. No.: US 2011/0022193 A1
(43) Pub. Date: Jan. 27, 2011

(54) METHOD AND APPARATUS OF A SELF-CONFIGURED, MODEL-BASED ADAPTIVE, PREDICTIVE CONTROLLER FOR MULTI-ZONE REGULATION SYSTEMS

(75) Inventor: Razvan Panaitescu, Alpharetta, GA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Industry, Inc., Alpharetta, GA (US)

(21) Appl. No.: 12/756,279

(22) Filed: Apr. 8, 2010

Related U.S. Application Data
(60) Provisional application No. 61/228,776, filed on Jul. 27, 2009.

(51) Int. Cl. G05B 13/04; G05D 23/19; B29C 39/00

(52) U.S. Cl. 700/29; 700/277; 700/197

(57) ABSTRACT

A control system simultaneously controls a multi-zone process with a self-adaptive model predictive controller (MPC), such as temperature control within a plastic injection molding system. The controller is initialized with basic system information. A pre-identification procedure determines a suggested system sampling rate, delays or “dead times” for each zone and initial system model matrix coefficients necessary for operation of the control predictions. The recursive least squares based system model update, control variable predictions and calculations of the control horizon values are preferably executed in real time by using matrix calculation basic functions implemented and optimized for being used in a S7 environment by a Siemens PLC. The number of predictions and the horizon of the control steps required to achieve the setpoint are significantly high to achieve smooth and robust control. Several matrix calculations, including an inverse matrix procedure performed at each sample pulse and for each individual zone determine the MPC gain matrices needed to bring the system with minimum control effort and variations to the final setpoint. Corrective signals, based on the predictive model and the minimization criteria explained above, are issued to adjust system heating/cooling outputs at the next sample time occurrence, so as to bring the system to the desired set point. The process is repeated continuously at each sample pulse.

### CLAIM TO PRIORITY

This application claims the benefit of co-pending United States provisional patent application entitled “Method and Apparatus of A Self-Configured, Model-Based Adaptive, Predictive Controller for Multi-zone Temperature Regulation Systems Using SIEMENS S7 Technology” filed Jul. 27, 2009 and assigned Ser. No. 61/228,776, which is incorporated by reference herein.

### BACKGROUND OF THE DISCLOSURE

1. Field of the Invention

The invention relates generally to process control systems and, more particularly, to online, self configured, model-based adaptive predictive process controllers for multi-zone systems, capable of regulating temperature, humidity, pressure, flow rates, and the like, that may be used in various process control application in industries such as, but not limited to, plastics, food and beverage, chemical, and pharmaceuticals. Each of those industries have applications that require precise temperature control systems, among other process control parameters.

2. Description of the Prior Art

Process control systems include one or more process controllers, such as programmable logic controllers (PLCs) working individually or in a networked communication system. The controllers cause controllable field devices, such as pressure, temperature or flow sensors, heating elements and valves to transmit input information to them. The controller analyzes the input information with control routines stored in the controller, in order to ascertain operating status of the controlled system. Commonly known controller routines employ feedback control loops, utilizing proportional-integral-derivative (PID), artificial intelligence (AI), fuzzy logic and single-loop adaptive model predictive control routines. In turn the controller, with the control routines, generates and issues control commands to the controllable field devices: for example, to increase heat or cooling in an injection molding machine, chillers, calcinators and the like.

Known modern control routines often require one or more of complicated pre-implementation routines, on-line “learning”, repetitive tuning, and limited single-loop control capabilities. They do not tend to adapt quickly or efficiently to transient operating conditions within the controlled process. Consider exemplary control system operating challenges in the plastics molding industry.

In the plastics industry, as in many others, temperature control is a critical element to product quality. Many applications use temperature control of the mold and barrel as in blow molding, injection molding and extrusion. Process control vendors, including Siemens Industry Inc., assignee of the present invention, have developed temperature PID control packages. Generally, users of temperature PID control packages consider them to be relatively sensitive to parameter variations. Such packages also require pre-start up tuning procedures that must be executed manually for initial machine temperature setup, before processing actual plastic feedstock into the manufacturing process. Many industrial customers involved in the process control industry are in need for a precise set point tuning for their applications. When using a relatively low quality, non-homogeneous plastic feed stock, the demanding +/−1 degree accuracy in temperature control can no longer be easily achieved due to fluctuations in feed stock consistency.

There are proposed temperature control solutions that are based on an adaptive algorithm to modify the PID controller parameters as needed by the changing characteristics of the process. It is difficult to develop a good self-tuning algorithm for temperature control. The PID controller is in general not a simple solution as it still requires intervention from the operator or user during machine startup or while running when dynamic conditions change.

Model predictive controller functionality exists in some industrial controller application environments, generally for relatively powerful platforms having high processor speeds and large internal memory dedicated to process control industry, but not for the relatively less powerful controller product lines. However, even these model predictive controller functionality applications are not self-configurable and they do not adapt parameters while the system is running. Users would prefer to minimize, if not totally eliminate, efforts necessary to perform any pre-configuration and tuning processes.

Thus, a need exists in the art for industrial process controllers that require minimal- and ideally no pre-configuration and tuning efforts prior to initiating a desired industrial control process.

There is a need in the art for industrial process controllers in multi-zone, interdependent environments, such as in plastic molding, that enable the control system to maintain steady-state operational conditions, despite transient variances in the controlled system, such as maintenance of temperature control +/−one degree.

The need also exists in the art for industrial process controllers in multi-zone, interdependent environments, such as in plastic molding, that self adapt to process variations at sufficient speed to maintain desired control output parameters without disruption.

### SUMMARY OF THE INVENTION

Accordingly, an object of the present invention is to develop a method and the apparatus of the above-mentioned type controller which would be used in various process control industries (such as plastics, food and beverage, chemical, pharmaceutical) that require precise temperature control systems, and require little or no intervention from the user for configuration, setup or tuning.

These and other objects are achieved in accordance with the present invention by determining the system parameters of each controlled zone (for example a temperature zone) and the correlation between these parameters continuously during heating and cooling phases and by using the information acquired to maintain individual set point temperatures on each zone of the temperature controlled system. The benefits of implementing such a controller are: (i) getting a more precise process (e.g., temperature) control; (ii) no setup or tuning required which would allow saving engineering costs during commissioning; and (iii) the controller self-adaptation allows dynamic parameter changes as process conditions or material characteristics change thus producing much better outputs, improving machine efficiency and shorten production cycle times.

In the present invention, after initialization of a control model based on knowledge of past and present process behavior, the controller calculates an initial model of system response. Thereafter the controller predictively models in real time over a “prediction horizon” the response of a controlled process parameter (e.g., temperature in a plastic molding machine extruder barrel) in each zone of a multi-zone system for a large number of future input samples (a non-limiting example being 50) at a designated system sampling rate. At each respective future sampling pulse the system recalculates the predictive model for the next future prediction horizon of samples (e.g., 50). The controller accumulates a plurality of successive predictive horizon process data values. Periodically over a “control horizon” of a plurality of control correction steps of a size less than the prediction horizon size but sufficiently large to effectuate smooth changes in the controlled system within a desired time period, the controller accumulates a plurality of predictive control horizon values. The accumulated predictive horizon data values are used to construct a predictive control model of future controlled apparatus response of the plurality of zones over the control horizon. It then compares the modeled predicted response with a desired response set point in each zone. The bias difference between the modeled and actual set point in each zone is used to formulate output commands to a process influencing output field device (e.g., a heater or cooling element in a plastic molding machine extruder barrel) necessary to move the measured process variable (e.g., temperature of a plastic molding machine extruder barrel) to its desired set point. The predictive modeling, subsequent use of the predictive models to construct a predictive control model of future system behavior, comparison of predictive control model to desired system set points, re-adjustment of the models, and changing of the controlled element to move the controlled variable to its desired set point is repetitively and continuously performed in real time during operation of the controlled system.

The controller of the present invention meets control range and transient response requirements from the process control industry, and when applied in an exemplary temperature control embodiment, additionally presents the following range of one or more exemplary features in preferred application embodiments:

Is capable of being implemented on relatively lower processor speed, limited internal memory controllers, such as SIMATIC® S7 controllers manufactured by Siemens Industry Inc. (e.g., models 315CPU, 317CPU, 319CPU), as well as higher processor speed and larger memory controllers, such as Siemens model PCS7 controllers, and controllers sold by other manufacturers.

Less than 3 degrees overshoot under normal operating conditions.

Temperature regulation within +/−1 degree, after disturbances and/or command changes have settled.

Handles zones with heat only, heat and air cool, and heat and water cool. Offsetting of parallel simultaneous heating and cooling operations can be performed so as to negate transient response uncertainties of starting and stopping either mode.

Commissioning is not required: the controller identifies by itself the starting parameters of each zone, sets the cycle time appropriately and determines the best prediction coefficients.

Tuning is not required: the controller self adjusts its tuning.

The tuning process always runs in the background.

System Identification always runs in the background.

Uses a Pseudo Random Binary Signal (PRBS) signal for system identification to simulate the response at all possible natural frequencies of the system being controlled.

In plastic molding applications, users do not have to start over and wait for plastic injection barrel to be cool in order to start tuning.

Provides tuning alarming and status results with the ability to load previous good values if a tuning operation fails.

Capable of tuning all system zones in parallel, up to the maximum number the hardware platform supports.

Modular in design such that zones can be easily added or subtracted when their corresponding input/output (IO) ports are available.

Any combination of the above-noted features may be utilized when practicing the present invention. For example, while the present invention is capable of practicing all tuning processes in the background without user intervention, one skilled in the art can appreciate that user intervention capabilities can be incorporated as desired. Similarly, those skilled in the art can appreciate to not all invention capabilities must be utilized in any given application.

### BRIEF DESCRIPTION OF THE DRAWINGS

The teachings of the present invention can be readily understood by considering the following detailed description in conjunction with the accompanying drawings, in which:

FIG. 1 is a schematic representation of a plastic molding machine incorporating the control system of the present invention to regulate temperature within an extruder barrel therein;

FIG. 2 is a functional block diagram representation of a controller architecture for a single exemplary zone within the plastic injection molding machine of FIG. 1;

FIGS. 3-5 are graphical representations of the adaptive predictive control function practiced by the controller of the present invention when adjusting temperature in a hypothetical extruder barrel of a plastic molding machine of FIG. 1;

FIG. 6 is a flow chart of the adaptive predictive control function operational steps practiced by the controller of the present invention;

FIG. 7 is an exemplary model process control block diagram; and

FIG. 8 is a block diagram of a system update sequence practiced by the controller of the present invention.

To facilitate understanding, identical reference numerals have been used, where possible, to designate identical elements that are common to the figures.

### DETAILED DESCRIPTION

After considering the following description, those skilled in the art will clearly realize that the teachings of the present invention can be readily utilized in multi-zone process control systems where self-configuring, real-time model-based adaptive, predictive functionality is beneficial for relatively easy startup commissioning, and responsiveness to transient conditions that might otherwise negatively impact desired process outcomes if not properly controlled. The teachings of the present invention can be utilized in whole or in part at the discretion of one skilled in the art. For example, the teachings of the present invention can be practiced in a single zone control system as well as a multi-zone system. Similarly, a user may at its discretion choose to provide manual inputs during the controller initialization phase.

Overview of General Functional Operation of the Present Invention

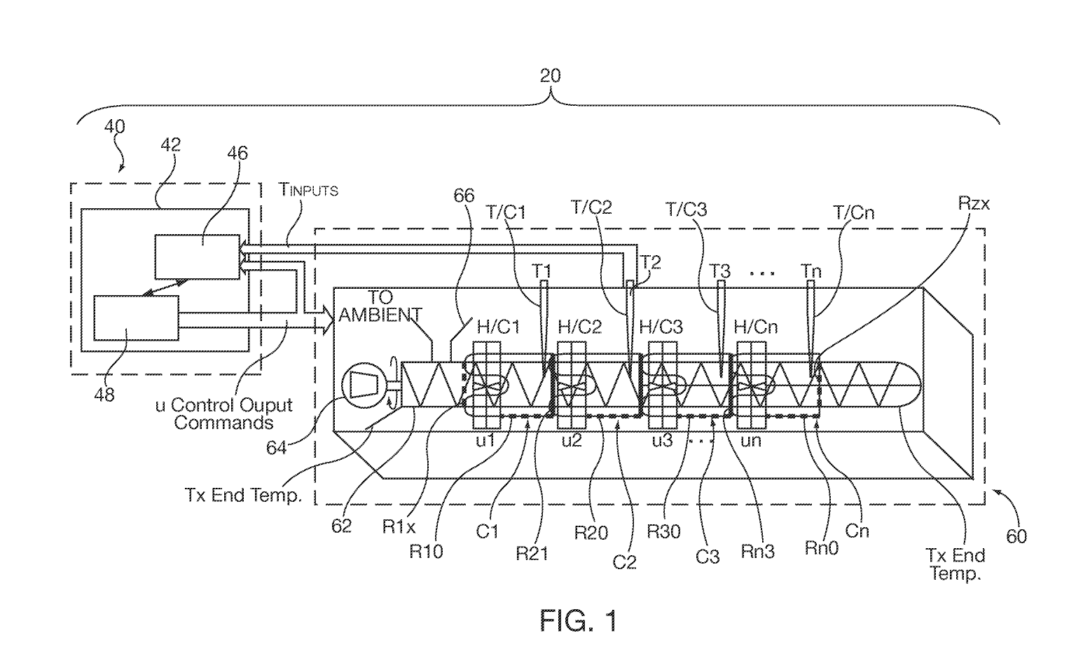

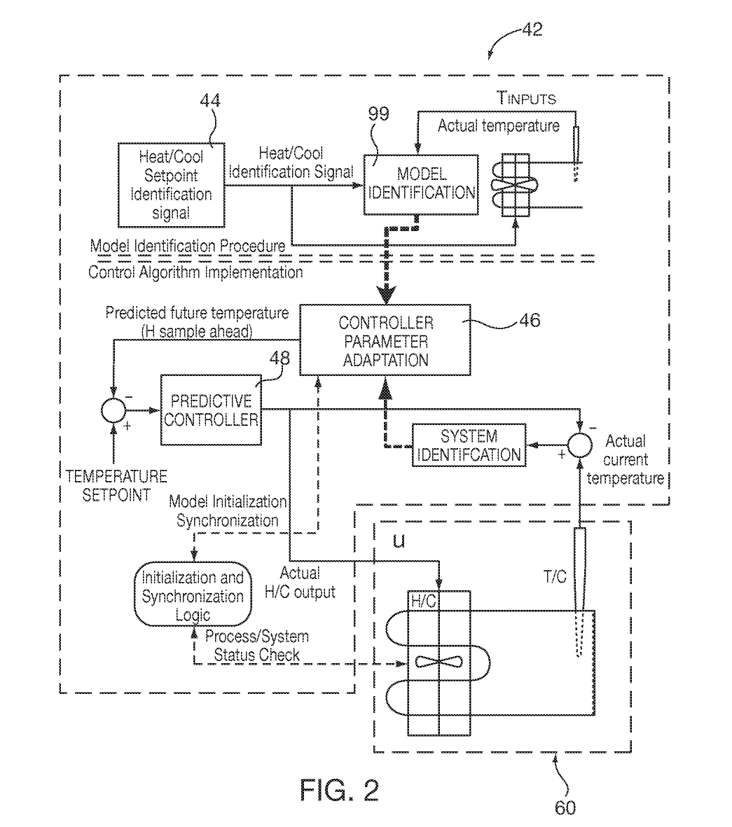

The functional operation of the present invention is shown and described in connection with an exemplary injection molding machine system 20 of FIGS. 1 and 2. System 20 includes a controller, such as a programmable logic controller 40 and multi-zone u1-un (where n=total number of zones) temperature control extruder barrel system 60 having an auger 62 driven by motor 64 and a plastic feed stock hopper 66.

The reference notations described herein include the output signals, u1-un, coming from the controller 40 as measured heating and/or cooling values to be applied by the extruder barrel system 60 heating or cooling elements H/C1-H/Cn at each zone 1-n; and the temperature readings T1-Tn fed back to the controller 40 by thermocouples T/C1-T/Cn, or other temperature sensing elements utilized in the barrel system 60. All other parameters in the system 20 refer to internal heat-transfer coefficients R that are taken into consideration when building up the system model used in the selected system identification adaptive algorithm, to be described herein. Specifically, the notation R10-Rn0 is the overall heat transfer coefficient for a control zone 1-n, and the notation Rxy signifies the heat transfer coefficient influencing the adjoining downstream control zone (e.g., R32 signifies the heat transfer coefficient of zone 2 that influences downstream zone 3). The notations C1-Cn represent the overall heat capacitance of each of the zones. As also used herein, the notation T0 refers to the system 20 ambient temperature, and Tx refers to both of the respective input and output temperatures of the barrel 40 ends, wherein R1x refers to the heat transfer coefficient influencing zone 1 from the input end of the barrel system 60 and RZx refers to the heat transfer coefficient influencing the output end of the barrel system 60 by the last downstream zone (here labeled zone n). While the exemplary embodiment described herein demonstrates application of the present invention in the environment of plastic molding temperature control, it should be understood by those skilled in the art that the present invention can be applied to controllers operating in other process control applications and that control parameters including pressure, position, flow rate, metering, manufactured product physical characteristics (e.g., dimensions, composition, conformance to specifications), on/off and the like, that are generally encountered in the process control industry.

As with any plastic injection molding system, the controller 40 receives temperature readings TINPUTS from the input field device thermocouples T/C in a feedback loop and adjusts the control output commands u to each heating/cooling element H/C. Temperature readings TINPUTS are sampled and outputs u are adjusted at designated clock rates. In the present invention the controller 40 uses the PRBS based identification process for determining the clock rate that will be effective for calculating the control horizon data simultaneously for all the heating/cooling elements H/C. In a given application, the control horizon is chosen so that the controller 40 can receive temperature inputs TINPUTS from the thermocouples TC, analyze the temperature information, determine how to adjust the control outputs u, command the heating/cooling elements H/C to implement the control output adjustments, allow sufficient time for heating/cooling element and other system phase lag (sometimes referred to by those skilled in the art as “delay” or “dead time”) necessary to effectuate the desired temperature changes, and give significant time to feed back the new TINPUTS temperature changes to the controller before the system overheats or overcools beyond system design parameters.

Based on system parameters and experience the control horizon is initially established by choosing a control clock rate and number of control adjustment steps. For example in a given application the control horizon may be set a 10 adjustment steps into the future. Alternatively, the control clock speed may be determined adaptively by the controller.

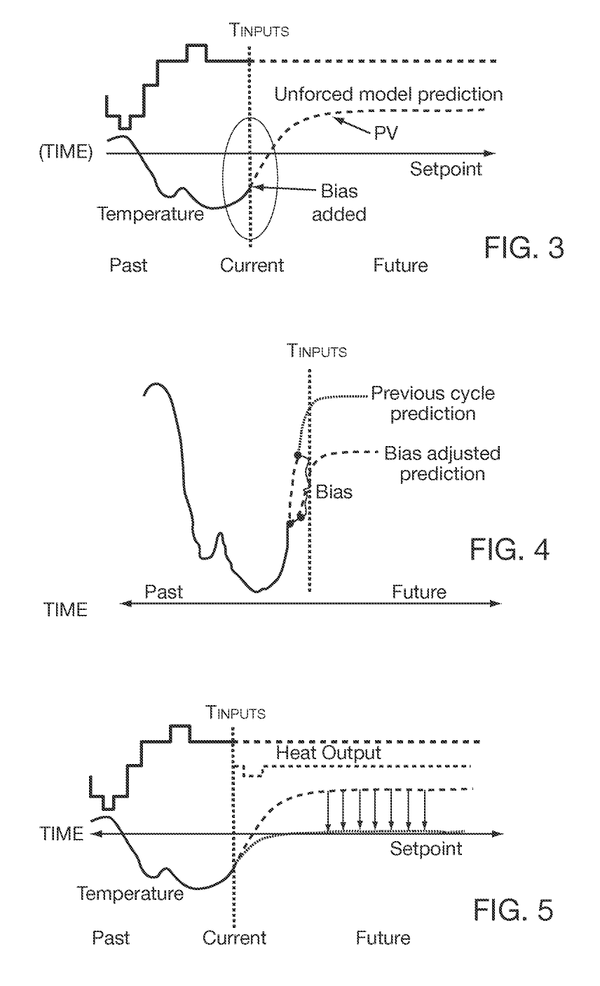

As previously noted, the controller of the present invention implements a predictive model of how the extruder barrel system will behave in the future. Future behavior is modeled in a prediction horizon of future temperature input samples. Preferably the controller 40 models system operation respecting the controlled parameter in the control horizon only on controlled parameter information contained in the predictive models rather than directly from the input field devices. The prediction horizon sampling rate and number of future sampling steps is a function of the controller 40 processor speed and available memory. For example, in a plastic injection molding control system the predictive controller may have a prediction horizon looking forward 50 samples. In such an exemplary application, the controller 40 will run a predictive model to model the temperature in a given zone 50 sampling pulses into the future, as shown in FIG. 3. At the next sample pulse, FIG. 4, the controller 40 acquires new temperature data TINPUT from each temperature sensor T/C, and will re-run the predictive model using these newly measured temperature samples TINPUTS for each zone for the next 50 future samples in the prediction horizon moving window to generate a bias adjusted prediction. The bias adjusted predictions, based on the latest temperature inputs are compared to respective ones predicted by the model based on the temperature samples acquired in the prior sample pulse (previous cycle prediction) and the difference (bias) is determined. Next, as shown in FIG. 5, the controller of the present accumulates a plurality of the predictive model horizons to construct a predictive control model of future system response for the future control steps and calculates the necessary control element output command change u necessary to move the controlled parameter (here temperature) to its desired set point, and runs a virtual model of how the command change will impact system response through the entire control horizon window (e.g., 10 future control command pulses), adjusting the command change assumption as necessary to achieve the desired result within the control horizon window.

Thereafter the controller 40, issues the desired command change to the associated heating/cooling element H/C at the next control horizon sequence pulse. As the controller 40 of the present invention also models future system response to control pulses u over a large number of future steps in the control horizon, resolution adjustments in virtual space reduces likelihood of system response variance from desired output objectives.

Among other benefits, the controller can respond to transient temperature readings, and using the control algorithms predicts system response to the temperature readings in “virtual space” before committing to an actual system output control command u. In this manner the injection molding system 20 employing the controller 40 of the present invention can better respond to externally induced transients (e.g., extruder barrel temperature fluctuations caused by variances in the plastic feed stock being fed into the barrel hopper 66 or a failing heating/cooling element H/C) and/or reduce likelihood of a heating/cooling element H/C overshooting its desired set point.

Control System Architecture and Functionality

The controller 40 architecture is shown in FIG. 2 where for brevity only one exemplary gone is described herein. It should be understood that the controller 40 simultaneously accesses multiple zones 1-n of the extruder barrel system 60. The number of zones depends on the processor speed and available memory of the controller platform utilized. It is noted that even a relatively simple controller, such as the Siemens model 315CPU S7 programmable logic controller previously described, employing the control system of the present invention, can control up to 40 plastic injection molding extruder barrel zones simultaneously, with 512 kB of memory. A higher speed processor having use of 1 MB of memory can process up to 100 zones simultaneously.

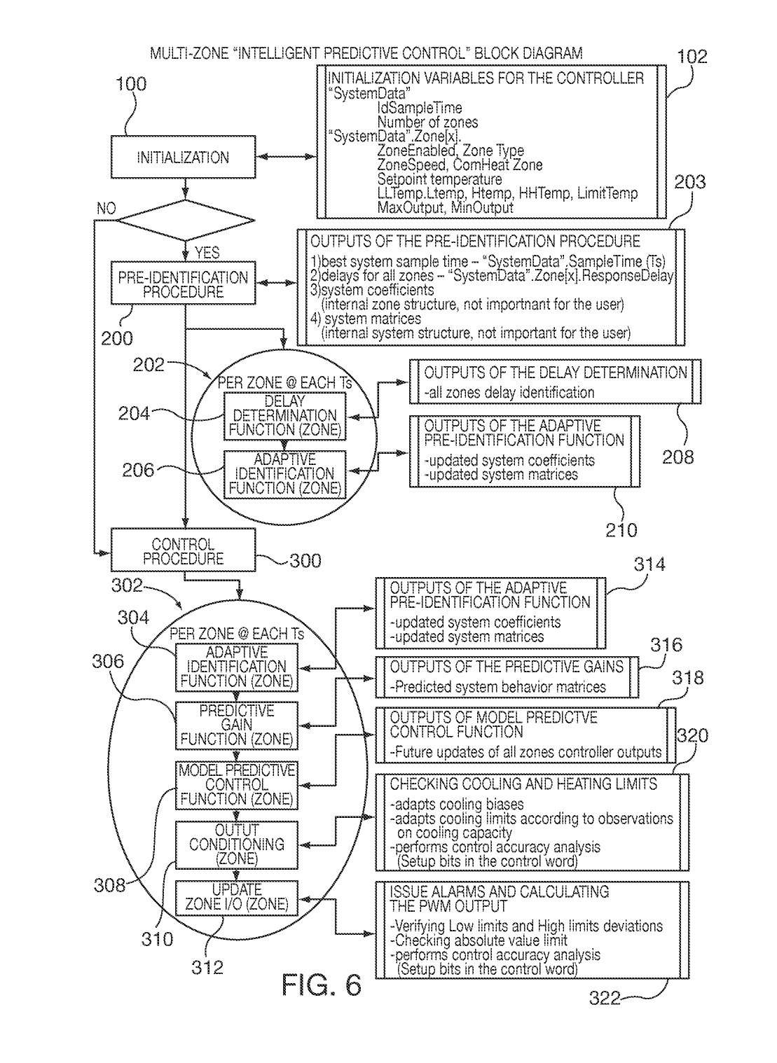

As previously noted, the control system of the present invention is implemented by one or more processors executing program instructions stored in accessible memory, firmware or a combination of both, all of which are designated 42 in FIGS. 1 and 2. The program instruction software may be stored independently from the controller 40 and thereafter downloaded into the controller in the field or via a data communications network, including the InternetController functionality, along with inputs and outputs are shown in greater detail in FIGS. 2 and 6, as will now be described in greater detail.

Referring generally to FIG. 6, the controller functionality can be divided into at least three phases:

Phase 1 is the MODEL IDENTIFICATION PROCEDURE 99, including adoption and adaptation of a modeling algorithm initially thought to be suitable for the system being controlled. In INITIALIZATION Mode step 100, the phase lag delay per each zone in the extruder system 60 and with that information, among others, the best cycle time for the control horizon to be utilized for each zone will be calculated. Generally, the shortest control window required for any zone in the extruder system 60 will be chosen for all zones. While it is possible to configure a system practicing the present invention with different control horizons for different zones and asynchronous response cycles, it is generally easier to implement a common control horizon for all zones, so long as the controller 40 has sufficient processing speed and memory to accomplish the control objectives. As noted in 102 of FIG. 6, initialization variables for the controller 40 may include operational parameters including temperature limits, output rates, number of zones, set point temperatures, sample time, manufactured product characteristics, etc. At the end of this phase the controller 40 is configured and is ready to execute the next phase.

During the initialization phase 100, the first order or “best guess” prediction horizon and control horizon sample time, as well as the delay times or lags in the extruder system 60 will be identified. In each respective individual zone, its type (i.e., heating or cooling or both), zone response speed (i.e., slow, medium or fast) and set point temperatures have been set by the operator. Acceptable system temperature limits and heating/cooling element output ranges can be defined.

Phase 2 is called the PRE-IDENTIFICATION Mode 200. All of the cooling/heating elements of all the extruder barrel system 60 zones are simultaneously excited, preferably with a Pseudo-Random Binary Signal (PRBS) generator 44 having amplitudes varying between 0% and 100% and accessed at independent cycle times, corresponding with the initial delay times calculated in the self-configuration INITIALIZATION phase 100. The PRBS procedure is utilized to produce all potential system 60 heating/cooling frequencies that are necessary to determine accurately the system coefficients that will be used in the modeling algorithms, described below, as well as to stimulate an effective system response.

During this phase 200 the system 60 is heated and the temperatures rise towards their zone set points, while the system parameters for each zone 202 are being determined, including phase lag delays 204 (corresponding output information 208) and refinement of its zone-specific predictive control algorithm 206 modeling matrices and their coefficients (corresponding output information 210). The summary of potential outputs of the pre-identification phase 203 include, among others, best overall system sampling time (Ts) for each of the zone temperature inputs TINPUTS, system best sample time, as well as system initial coefficients used in the modeling algorithms and system matrices used to perform the predictive calculations of the modeling algorithms within the bounds of limited processor capability in the controller 40. As explained below, each zone is modeled as a third order differential equation within a matrix construct. Thus each individual zone solution requires three mathematical coefficients. Modeling will be performed in system matrices that will be used during actual control execution. Once enough information has been obtained about the system 60, the controller 40 takes the decision to stop the identification and enter the next and last phase.

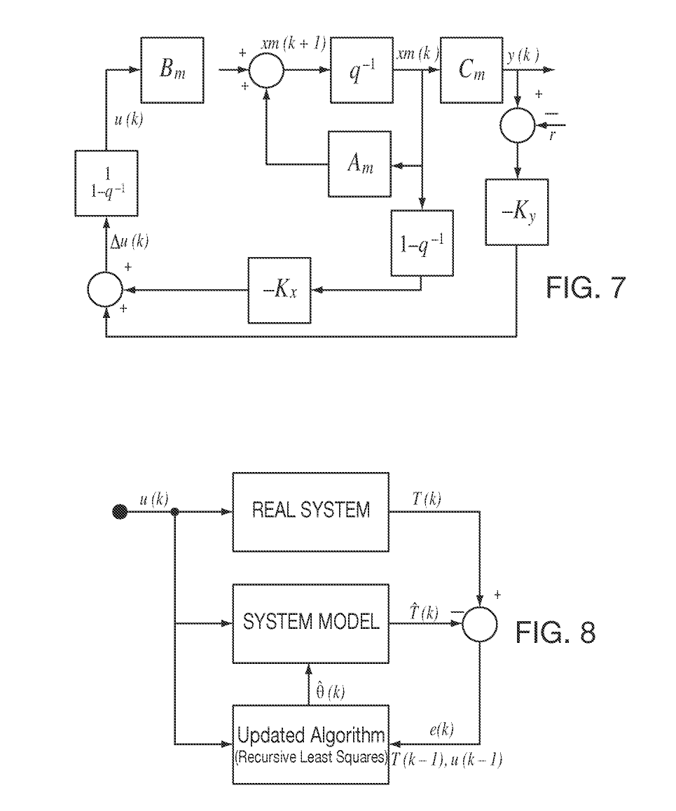

Phase 3 is called the CONTROL PROCEDURE Mode 300, wherein the controller 40 performs on each zone (step 302), each cycle time of the respective modeling horizons the following operations 304-312 with the indicated corresponding exemplary outputs 314-322: updates the system parameters in the controller parameter adaptation functional activity 46 via an adaptation algorithm, updates the controller gains with the predictive controller function 48, using the classic model predictive method of FIG. 7, calculates the cooler/heater H/C new outputs for each zone and updates these values at the H/C power switching devices (for example a pulse width modulation (PWM) circuit before waiting for another control horizon cycle clock to issue the output command to the output field device H/C).

In the main control procedure, the system dynamic behavior is modeled using a known recursive least squares (RLS) mathematical model, based on memorized past outputs and inputs, as well as delay phase lag or “dead time” information that was obtained in the pre-identification step. With usage of the RLS models in each zone, the zone model coefficients used in the modeling matrices are updated. In turn the system and model predictive system matrices are updated, as shown in FIG. 8.

In an exemplary embodiment, the predictive controller 48 uses the model predictive control (MPC) matrices to build a 10 step control horizon and a 50 step temperature prediction horizon. The MPC matrices are prepared and constructed in the controller 40 processor and memory devices 42. The underlying system model matrices are updated first, based on past data. Using the updated system model, 50 step temperature predictions are computed. By comparing the predicted values with the setpoint and trying to minimize the deviation while maintaining a smooth control, a 10 step future control horizon is calculated. With respect to plastic molding temperature control implementation in the previously described Siemens S7 controller/processor the basic matrix computational routines desirably may be optimized and implemented for the S-7 PLC environment. An inverse of a 10×10 matrix using a Gauss-Jordan approach, optimized to run on a fixed data structure and limiting computational floating point capability of the S-7 PLC processor may be employed when practicing this invention. Those skilled in the art can appreciate that controllers manufactured by others may require different operational optimization parameters.

Next the model predictive control update function is performed by using basic mathematical matrix operations as applied to the system matrices and control matrices obtained previously to determine the new incremental output Δu. The new incremental output Δu is expressed as a differential vector modification of prior heating and cooling variables, and is stored in a mathematical matrix vector of dimension equal to the number of zones n. This result is added to the previous output vector to generate the new output vector u.

The heating and cooling outputs u1-un are evaluated to determine whether they are within allowed minimum and maximum limits. Another feature of the present invention that may be implemented is application of offsetting heating and cooling biases in zones having both heating and cooling elements H/C. When utilizing this feature a small percentage of simultaneous heating and cooling is always maintained. Any differential increase in either heating or cooling is more likely to generate a more desirable linear H/C system response in the affected zone, leading to more precise temperature adjustment trim. In comparison, control zones that must transition from a heating to a cooling state or vice versa via an ON-OFF transition often experience non-linear responses that increase the likelihood of system control instabilities. If desired, alarm and status registries routinely maintained in PLC control routines may be updated to reflect changes in system control parameters and operations.

The CONTROL PROCEDURE 300 is preferably performed continuously with each new sample. All matrix and control output calculations are performed within the system sample time interval. However, one skilled in the art may choose to run the CONTROL PROCEDURE synchronously or asynchronously throughout the control process, depending upon the needs of any particular system.

Exemplary Predictive Modeling Algorithms and Implementation

An exemplary mathematical model of the extruder thermal behavior suitable for practicing the present invention in a model predictive controller (MPC) is:

$${C}_{i} \frac{d {T}_{i} ( t )}{d t} = {k}_{i} \cdot {\overline{u}}_{i} ( t ) - \frac{1}{{R}_{i + 1 , i}} ( {T}_{i} ( t ) - {T}_{i + 1} ( t ) ) - \frac{1}{{R}_{i , i - 1}} ( {T}_{i} ( t ) - {T}_{i - 1} ( 1 ) ) - \frac{1}{{R}_{i , 0}} ( {T}_{i} ( t ) - {T}_{0} ( t ) ) + {ɛ}_{i} ( t )$$

i= 1̅,̅Z̅ where Z-number of zones
Cᵢ Thermal capacity of zone i
R_{i,j} Thermal resistance between zones i and j
εᵢ Stochastic disturbance, modeled as white Gaussian noise
kᵢūᵢApplied thermal energy rate

Those skilled in the art may wish to apply a different thermal modeling algorithm.

System response delay may be modeled with the following differential equation:

$$\frac{d T ( t )}{d t} = \tilde{A} \cdot T ( t ) + • B \cdot \overline{u} ( t ) + Φ ( t ) + ɛ ( t )$$

One skilled in the art can appreciate that the delay equation can be restated as a discrete time domain model:

T(k)=A˜T(k−1)+B₀˜u(k−d)+B₁˜u(k−d−1)+Φε(k)

A classic MPC functional block diagram is shown in FIG. 7. Equations for each zone are modeled in a matrix within processor and memory 42 of the controller 40. The model is preferably updated each control cycle, as shown in FIG. 8

Summary of Benefits of Present Invention Controller

The potential range of significant performance benefits arising from practice of the present invention temperature control strategies, even when implemented on relatively low memory capacity programmable logic controllers such as the Siemens SIMATIC® S-7 platform are:
Functions are modular, permitting an easy upgrade of a one-zone module to a multiple zone module machine control structure;
The sample time and controller predictive settings can be automatically calculated during the pre-identification phase, with no intervention from the user;
The model identification uses PRBS signals to excite the multiple frequencies in each zone during the pre-identification phase, so that the full potential range of frequencies is identified;
The controller is capable to calculate a multiple of up to 50 cycle clock predictions ahead which can give a very smooth control and produce precise results;
The system model per zone is based on a State-Space representation and physical parameters of the temperature to heater input transfer function;
The zone model utilized in this invention takes into consideration physical reality that heating and cooling phenomena have different time constants, and the processes monitored in each zone are inter-dependent with ambient temperature and adjacent zone heaters and/or current temperatures;
The zone model is able to capture and adjust controller settings when variations in the process, the zone structure, or zone interaction are happening, without needing user intervention;
The system identification is running continuously at each sample time for the best possible control parameters adaptation;
The implementation uses processor and memory efficient advanced matrix computational techniques: matrix multiplication, addition, subtraction, transpose and inverse.

Although various embodiments which incorporate the teachings of the present invention have been shown and described in detail herein, those skilled in the art can readily devise many other varied embodiments that still incorporate these teachings.

What is claimed is:

1. A model-based adaptive, predictive process control system comprising:
a multi-zoned regulated apparatus having in each zone at least one input field device that measures a controlled parameter and at least one output field device capable of influencing the controlled parameter;
a controller coupled to the respective field devices and performing the following operational steps in at least a plurality of the zones in real time:
periodically sampling the controlled parameter with the respective input field device and predictively modeling future sample readings thereof in a moving window prediction model horizon;
accumulating a plurality of the moving window prediction model horizons and periodically, in a moving window control horizon, predictively modeling future controlled apparatus response of the plurality of zones as a function of the accumulated prediction model horizons;
comparing the modeled response of the controlled apparatus in the control horizon to a desired response; adjusting the system model based on past measurements;
adjusting the respective output field device in order to attempt to converge modeled and desired responses; and
periodically repeating the above controlled functions.

2. The system of claim 1, wherein prior to the sampling step the controller performs an initialization step comprising:
receiving operational parameter inputs selected from the group consisting of: number of zones, sampling rates for horizons, type of controlled parameter, anticipated system zone response speed to controlled parameter changes, system boundary and operational limits and system initial conditions.

3. The system of claim 2 further comprising initialization steps of:
exciting simultaneously the field output devices of all of the plurality of zones with an identification excitation signal and sampling the respective field input devices to identify system response parameters for the predictive modeling horizon window sampling;
approximating overall system response sampling rates for at least one of the horizons;
determining system response delays to field output device adjustments for each of the respective zones; and
preparing model predictive matrices in the controller for performing the modeling steps, and initializing matrix coefficients for system modeling parameters.

4. The system of claim 3, wherein the identification excitation signal is a pseudo random binary signal (PRBS) with amplitudes varying between 0% and 100% simultaneously applied to all of the plurality of zones.

5. The system of claim 1, wherein the controlled parameter is selected from the group consisting of current, voltage, temperature, humidity, pressure, flow rate and manufactured product specifications.

6. The system of claim 5, wherein the controlled parameter is temperature and the controlled system is selected from the group consisting of plastic molding machines, and heating ventilating and air conditioning (HVAC) systems.

7. The system of claim 6, wherein at least one zone output field devices are coupled to respective heating and cooling elements that operate with opposed output offsets and system temperature in said zone is regulated by increasing output of one of the elements while simultaneously maintaining a small bias value of the other opposing element.

8. The system of claim 1, wherein modeling is performed by the controller with mathematical matrix operations, matrix dimensions established by the respective numbers of steps in the horizons, with the modeled response matrix operations utilizing predictive model matrices; and the models update matrix coefficients during subsequent repetitive modeling steps in future horizon modeling.

9. The system of claim 8, wherein the system model has matrix coefficients that are updated using recursive least squares computational methods.

10. The system of claim 9, wherein the output field device adjustments are modified by differential adjustment of the existing adjustment stored within the controller.

11. A model-based adaptive, predictive process controller capable of being coupled to at least one input field device that measures a controlled parameter and at least one output field device capable of influencing the controlled parameter for each respective zone of a multi-zoned regulated apparatus, the controller capable of performing the following operational steps in at least a plurality of the zones in real time:
periodically sampling the controlled parameter with the respective input field device and predictively modeling future sample readings thereof in a moving window prediction model horizon;
accumulating a plurality of the moving window prediction model horizons and periodically, in a moving window control horizon, predictively modeling future controlled apparatus response of the plurality of zones as a function of the accumulated prediction model horizons;
comparing the modeled response of the controlled apparatus in the control horizon to a desired response;
adjusting the system model based on past measurements;
adjusting the respective output field device in order to attempt to converge modeled and desired responses; and
periodically repeating the above controlled functions.

12. The controller of claim 11, wherein prior to the sampling step the controller performs an initialization step comprising:
receiving operational parameter inputs selected from the group consisting of:
number of zones, sampling rates for horizons, type of controlled parameter, anticipated system zone response speed to controlled parameter changes, system boundary and operational limits and system initial conditions.

13. The controller of claim 12 further comprising initialization steps of:
exciting simultaneously the field output devices of all of the plurality of zones with an identification excitation signal and sampling the respective field input devices to identify system response parameters for the predictive modeling horizon window sampling;
approximating overall system response sampling rates for at least one of the horizons;
determining system response delays to field output device adjustments for each of the respective zones; and
preparing model predictive matrices in the controller for performing the modeling steps, and initializing matrix coefficients for system modeling parameters.

14. The controller of claim 13, wherein the identification excitation signal is a pseudo random binary signal (PRBS) with amplitudes varying between 0% and 100% simultaneously applied to all of the plurality of zones.

15. The controller of claim 11, wherein the controlled parameter is selected from the group consisting of current, voltage, temperature, humidity, pressure flow rate and manufactured product specifications.

16. The controller of claim 15, wherein the controlled parameter is temperature and the controlled system is selected from the group consisting of plastic molding machines, and heating ventilating and air conditioning (HVAC) systems.

17. The controller of claim 16, wherein at least one zone output field devices are coupled to respective heating and cooling elements that operate with opposed output offsets and system temperature in said zone is regulated by increasing output of one of the elements while simultaneously maintaining a small bias value of the other opposing element.

18. The controller of claim 11, wherein modeling is performed by the controller with mathematical matrix operations, matrix dimensions established by the respective numbers of steps in the horizons, with the modeled response matrix operations utilizing predictive model matrices; and the models update matrix coefficients during subsequent repetitive modeling steps in future horizon modeling.

19. The controller of claim 18, wherein the system model has matrix coefficients that are updated using recursive least squares computational methods.

20. The controller of claim 19, wherein the output field device adjustments are modified by differential adjustment of the existing adjustment stored within the controller.

21. In a process control system including a multi-zoned regulated apparatus having in each zone at least one input field device that measures a controlled parameter and at least one output field device capable of influencing the controlled parameter, and a controller coupled to the respective field devices, a method for operating the controller in real time, comprising the steps of:
periodically sampling the controlled parameter with the respective input field device and predictively modeling future sample readings thereof in a moving window prediction model horizon;
accumulating a plurality of the moving window prediction model horizons and periodically, in a moving window control horizon, predictively modeling future controlled apparatus response of the plurality of zones as a function of the accumulated prediction model horizons;
comparing the modeled response of the controlled apparatus in the control horizon to a desired response;
adjusting the system model based on past measurements;
adjusting the respective output field device in order to attempt to converge modeled and desired responses; and
periodically repeating the above controlled functions.

22. The method of claim 21, wherein prior to the sampling step the controller performs an initialization step comprising:
receiving operational parameter inputs selected from the group consisting of: number of zones, sampling rates for horizons, type of controlled parameter, anticipated system zone response speed to controlled parameter changes, system boundary and operational limits and system initial conditions.

23. The method of claim 22 further comprising initialization steps of:
exciting simultaneously the field output devices of all of the plurality of zones with an identification excitation signal and sampling the respective field input devices to identify system response parameters for the predictive modeling horizon window sampling;
approximating overall system response sampling rates for at least one of the horizons;
determining system response delays to field output device adjustments for each of the respective zones; and
preparing model predictive matrices in the controller for performing the modeling steps, and initializing matrix coefficients for system modeling parameters.

24. The method of claim 23, wherein the identification excitation signal is a pseudo random binary signal (PRBS) with amplitudes varying between 0% and 100% simultaneously applied to all of the plurality of zones.

25. The method of claim 21, wherein the controlled parameter is selected from the group consisting of current, voltage, temperature, humidity, pressure flow rate and manufactured product specifications.

26. The method of claim 25, wherein the controlled parameter is temperature and the controlled system is selected from the group consisting of plastic molding machines, and heating ventilating and air conditioning (HVAC) systems.

27. The method of claim 26, wherein at least one zone output field devices are coupled to respective heating and cooling elements that operate with opposed output offsets and system temperature in said zone is regulated by increasing output of one of the elements while simultaneously maintaining a small bias value of the other opposing element.

28. The method of claim 21, wherein modeling is performed by the controller with mathematical matrix operations, matrix dimensions established by the respective numbers of steps in the horizons, with the modeled response matrix operations utilizing predictive model matrices; and the models update matrix coefficients during subsequent repetitive modeling steps in future horizon modeling.

29. The method of claim 28, wherein the system model has matrix coefficients that are updated using recursive least squares computational methods.

30. The method of claim 29, wherein the output field device adjustments are modified by differential adjustment of the existing adjustment stored within the controller.

31. A storage medium comprising model-based adaptive, predictive process controller software capable of execution by a processor within a process controller, wherein the controller is in turn coupled to at least one input field device that measures a controlled parameter and at least one output field device capable of influencing the controlled parameter for each respective zone of a multi-zoned regulated apparatus, the software when executed by the processor causing the controller to perform the following operational steps in at least a plurality of the zones in real time:
periodically sampling the controlled parameter with the respective input field device and predictively modeling future sample readings thereof in a moving window prediction model horizon;
accumulating a plurality of the moving window prediction model horizons and periodically, in a moving window control horizon, predictively modeling future controlled apparatus response of the plurality of zones as a function of the accumulated prediction model horizons;
comparing the modeled response of the controlled apparatus in the control horizon to a desired response;
adjusting the system model based on past measurements;
adjusting the respective output field device in order to attempt to converge modeled and desired responses; and
periodically repeating the above controlled functions.

32. A model-based adaptive, predictive process controller capable of being coupled to at least one input field device that measures a controlled parameter and at least one output field device capable of influencing the controlled parameter for each respective zone of a multi-zoned regulated apparatus, the controller having means for performing the following operational steps in at least a plurality of the zones in real time:
periodically sampling the controlled parameter with the respective input field device and predictively modeling future sample readings thereof in a moving window prediction model horizon;
accumulating a plurality of the moving window prediction model horizons and periodically, in a moving window control horizon, predictively modeling future controlled apparatus response of the plurality of zones as a function of the accumulated prediction model horizons;
comparing the modeled response of the controlled apparatus in the control horizon to a desired response;
adjusting the system model based on past measurements;
adjusting the respective output field device in order to attempt to converge modeled and desired responses; and
periodically repeating the above controlled functions.
